(19) United States
(12) Patent Application Publication
(10) Pub. No.: US 2011/0284199 A1
(43) Pub. Date: Nov. 24, 2011

(54) Cooling Module

(76) Inventors: Alex Horng, Kaohsiung (TW); Chih-Hao Chung, Kaohsiung (TW); Yu-Yuan Lu, Kaohsiung (TW)

(21) Appl. No.: 12/781,920

(22) Filed: May 18, 2010

(51) Int. Cl. G05D 23/19

(52) U.S. Cl. 165/287

(57) ABSTRACT

A cooling module comprises a heat sink, a cooling fan, a control assembly, a temperature sensor and a resilient heat conductor. The cooling fan facilitates cooling efficiency of the heat sink. The control assembly has a circuit board controlling rotation of the cooling fan. The temperature sensor is coupled to the circuit board of the control assembly and has a sensing face. The resilient heat conductor is disposed between the heat sink and the temperature sensor and has a first contact face and a second contact face, wherein the first contact face contacts the sensing face of the temperature sensor and the second contact face contacts a face of the heat sink.

### BACKGROUND OF THE INVENTION

1. Field of the Invention

The present invention generally relates to a cooling module and, more particularly, to a cooling module that controls operation modes of a cooling fan based on a sensing result of a temperature sensor.

2. Description of the Related Art

Referring to FIG. 1, a conventional cooling module 9 is disclosed. The cooling module 9 comprises a heat sink 91, a cooling fan 92, a circuit board 93 and a temperature sensor 94. The heat sink 91 comprises a plurality of fins 911. The cooling fan 92 comprises a base 921 coupling with the heat sink 91. The circuit board 93 is disposed on a face of the base 921. The temperature sensor 94 has a sensing face 941 and a plurality of pins 942 electrically connected to the circuit board 93.

The base 921 comprises an indented hole 922. The pins 942 of the temperature sensor 94 extend through the indented hole 922 when the circuit board 93 is disposed on the face of the base 921, allowing the sensing face 941 to contact the surface of the heat sink 91. In this way, the temperature sensor 94 may detect the temperature of the heat sink 91 when the cooling module 9 is equipped in an electronic device for cooling purpose. Accordingly, the operation modes of the cooling fan 92 may be controlled based on the detected temperature. For example, the rotational speed of the cooling fan 92 may be increased to enhance the air flow when the temperature sensor 94 detects that the temperature of the heat sink 91 is too high. On the contrary, the rotational speed of the cooling fan 92 may be reduced to reduce power consumption when the temperature sensor 94 detects that the temperature of the heat sink 91 is too low.

During the use of the cooling module 9, the sensing face 941 of the temperature sensor 94 preferably contacts the surface of the heat sink 91 to better detect the temperature of the heat sink 91. However, as shown in FIGS. 1 and 2, the sensing face 941 of the temperature sensor 94 may not properly contact the surface of the heat sink 91 (as shown in FIG. 2) if the base 921 is not well-fixed to the heat sink 91 or the base 921 and the heat sink 91 have large tolerances in size. As a result, a gap exists between the sensing face 941 and the surface of the heat sink 91, resulting in a difficulty in accurately detecting the temperature of the heat sink 91. In another case, if the base 921 and the heat sink 91 are coupled with each other too closely, the temperature sensor 94 is easy to be damaged due to the pressing of the heat sink 91.

The cooling module 9 as a whole does not have structures which allow the sensing face 941 of the temperature sensor 94 to properly contact the surface of the heat sink 91. Hence, the detection of the temperature sensor 94 is not in accuracy. In addition, contact between the sensing face 941 of the temperature sensor 94 and the heat sink 91 has to be ensured during assembly of the cooling module 9, leading to an inconvenience during assembly. Therefore, it is desired to improve the cooling module 9.

### SUMMARY OF THE INVENTION

It is therefore the primary objective of this invention to provide a cooling module which allows a temperature sensor thereof to accurately detect the temperature of a heat sink.

It is another objective of this invention to provide a cooling module with easy assembly.

The invention discloses a cooling module comprising a heat sink, a cooling fan, a control assembly, a temperature sensor and a resilient heat conductor. The cooling fan facilitates cooling efficiency of the heat sink. The control assembly has a circuit board controlling rotation of the cooling fan. The temperature sensor is coupled to the circuit board of the control assembly and has a sensing face. The resilient heat conductor is disposed between the heat sink and the temperature sensor and has a first contact face and a second contact face, wherein the first contact face contacts the sensing face of the temperature sensor and the second contact face contacts a face of the heat sink.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a side cross-sectional view of a conventional cooling module.

FIG. 2 shows a partially enlarged diagram of the conventional cooling module.

FIG. 3 shows an exploded diagram of a cooling module according to an embodiment of the invention.

FIG. 4 shows a side cross-sectional view of the cooling module according to the embodiment of the invention.

FIG. 5 shows a partially enlarged diagram of the cooling module before assembly according to the embodiment of the invention.

FIG. 6 shows a partially enlarged diagram of the cooling module after assembly according to the embodiment of the invention.

FIG. 7 shows a first side cross-sectional view of a cooling module according to another embodiment of the invention.

FIG. 8 shows a second side cross-sectional view of the cooling module according to another embodiment of the invention.

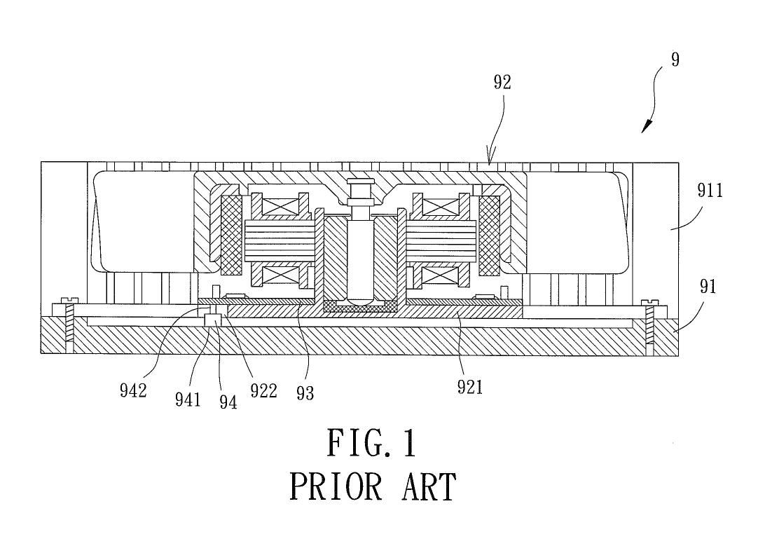

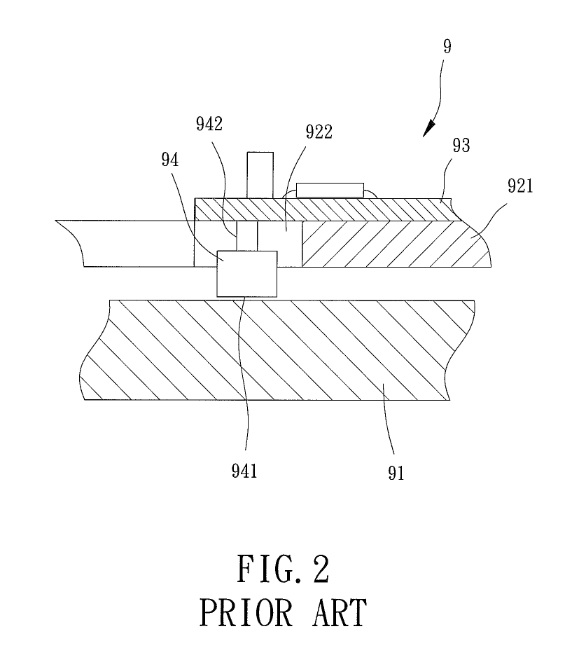

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

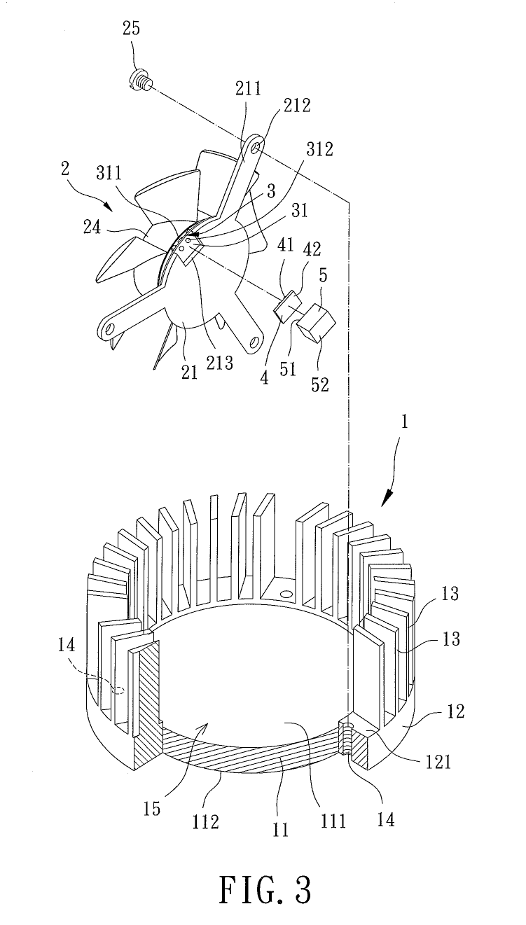

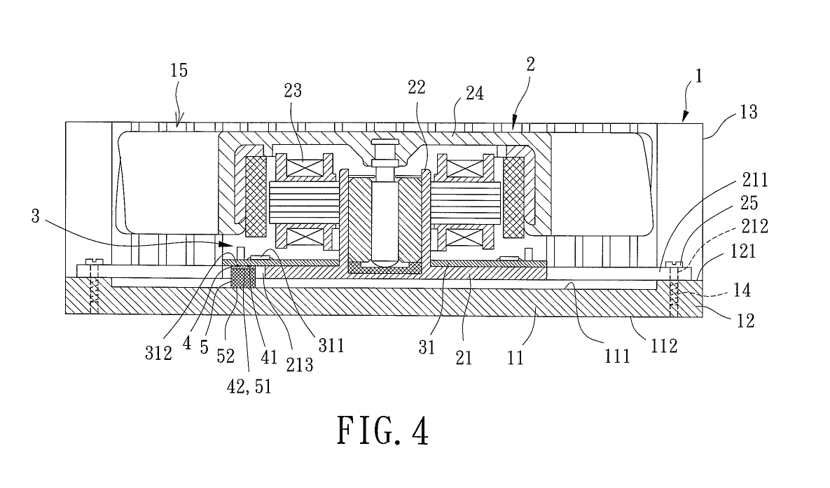

Referring to FIGS. 3 and 4, a cooling module comprises at least a heat sink 1, a cooling fan 2, a control assembly 3, a temperature sensor 4 and a resilient heat conductor 5 according to a preferred embodiment of the invention. The heat sink 1 may be equipped in various electronic devices for heat dissipation. The cooling fan 2 is coupled to the heat sink 1 to facilitate cooling efficiency of the heat sink 1. The control assembly 3 is electrically connected to the temperature sensor 4 and used to trigger the operation of the cooling fan 2. The resilient heat conductor 5 may be any resilient materials capable of conducting heat such as a rubber. The resilient heat conductor 5 is disposed between the control assembly 3 and the temperature sensor 4 so that the temperature sensor 4 is allowed to accurately detect the temperature of the heat sink 1.

The heat sink 1 comprises a seat 11 having a first face 111 and a second face 112 opposing to the first face 111. An outer annual portion 12 is preferably formed along a periphery of the seat 11. The outer annual portion 12 has a protruding face 121 and a height difference exists between the protruding face 121 and the first face 111. The protruding face 121 is mounted with a plurality of fins 13 and has a plurality of coupling holes 14. The fins 13 may be annually arranged to form a receiving space 15, with a spacing being formed between two adjacent fins 13. Each coupling hole 14 is located between two adjacent fins 13.

The cooling fan 2 comprises a base 21 having an axial coupling portion 22 and a coil unit 23. The axial coupling portion 22 couples with an impeller 24 and the coil unit 23 drives the impeller 24 to rotate. The base 21 has a plurality of supporting ribs 211 extending from a periphery thereof, with each supporting rib 211 having a through-hole 212. Based on this, the supporting ribs 211 of the base 21 may couple with the protruding face 121 of the heat sink 1 when the cooling fan 2 is disposed in the receiving space 15 of the heat sink 1, wherein each through-hole 212 is aligned with a corresponding coupling hole 14. In this way, a plurality of fixing members 25 such as screws, screw bolts or rivets may extend through the through-holes 212 and is fixed in the coupling holes 14. Thus, the cooling fan 2 and the heat sink 1 are coupled with each other.

The control assembly 3 comprises a circuit board 31 having an electronic component 311 and a first electrical connection port 312. The electronic component 311 may be composed of at least one active or passive electronic element. In addition, the electronic component 311 is electrically connected to the coil unit 23 of the cooling fan 2 so as to control the coil unit 23 to drive the impeller 24.

The temperature sensor 4 comprises a second electrical connection port 41 and a sensing face 42. The second electrical connection port 41 is electrically connected to the first electrical connection port 312. The sensing face 42 faces the first face 111 of the seat 11.

The resilient heat conductor 5 is disposed between the first face 111 of the seat 11 and the temperature sensor 4. The resilient heat conductor 5 is preferably in form of a block with good heat conductivity and flexibility. In a further preferred case, the resilient heat conductor 5 has insulation function to avoid problems such as electricity leakage. Moreover, the resilient heat conductor 5 has a first contact face 51 and a second contact face 52 opposing to the first contact face 51, with the first contact face 51 contacting the sensing face 42 of the temperature sensor 4 and the second contact face 52 contacting the first face 111 of the seat 11.

When in use, the second face 112 of the heat sink 1 may contact some portions of electronic devices where a significant amount of heat is generated. In this way, cooling of the electronic devices is achieved. Furthermore, the temperature sensor 4 may detect the temperature of the heat sink 1 and the operation modes of the cooling fan 2 may be controlled based on the detected temperature. For example, the rotational speed of the cooling fan 2 may be increased to enhance the air flow when the temperature sensor 4 detects that the temperature of the heat sink 1 is too high. On the contrary, the rotational speed of the cooling fan 2 may be reduced to save power when the temperature sensor 4 detects that the temperature of the heat sink 1 is too low. In this way, overuse of the cooling fan 2 is avoided and cooling efficiency is also increased.

With the structural features described above, the invention is mainly characterized by the following points.

Referring to FIGS. 4 to 6, when the base 21 of the cooling fan 2 is assembled in the heat sink 1, the resilient heat conductor 5 may fill up any potential gaps between the sensing face 42 of the temperature sensor 4 and the first face 111 of the heat sink 1. In addition, the resilient heat conductor 5 may closely contact the temperature sensor 4 and the seat 11 without any potential gaps based on the resilience thereof, as shown in FIG. 6. In this way, the temperature sensor 4 is allowed to accurately detect the temperature of the heat sink 1 via the resilient heat conductor 5. In addition, the resilient heat conductor 5 may also prevent the damage of the temperature sensor 4 caused by the pressing of the heat sink 1.

Based on the structural features described above, the proposed cooling module may further comprise one or more of the following secondary features for further improvement, as elaborated below.

Referring to FIGS. 3 and 4, the circuit board 31 of the control assembly 3 may be directly disposed on the base 21 of the cooling fan 2 to reinforce the positioning of the control assembly 3. The first electrical connection port 312 preferably faces the first face 111 of the seat 11 to allow easy electrical connection between the second electrical connection port 41 and the first electrical connection port 312.

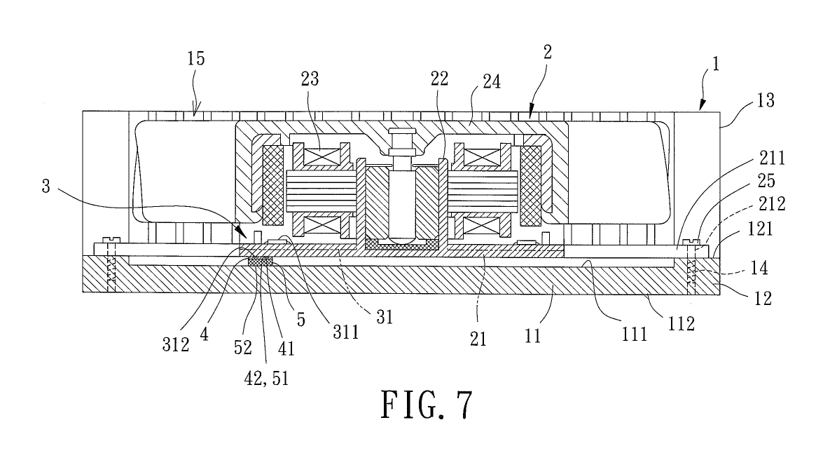

Referring to FIG. 7, the circuit board 31 of the control assembly 3 may be integrally formed with the base 21 of the cooling fan 2. That is, the base 21 may be regard as part of the circuit board 31 or the circuit board 31 may be regarded as part of the base 21. Thus, structure complexity of the cooling module is simplified and assembly convenience is improved.

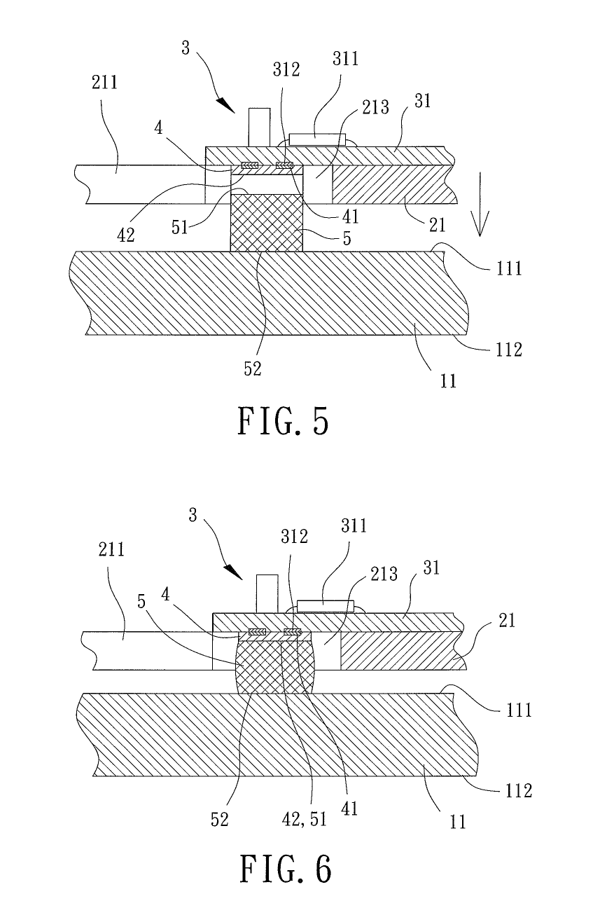

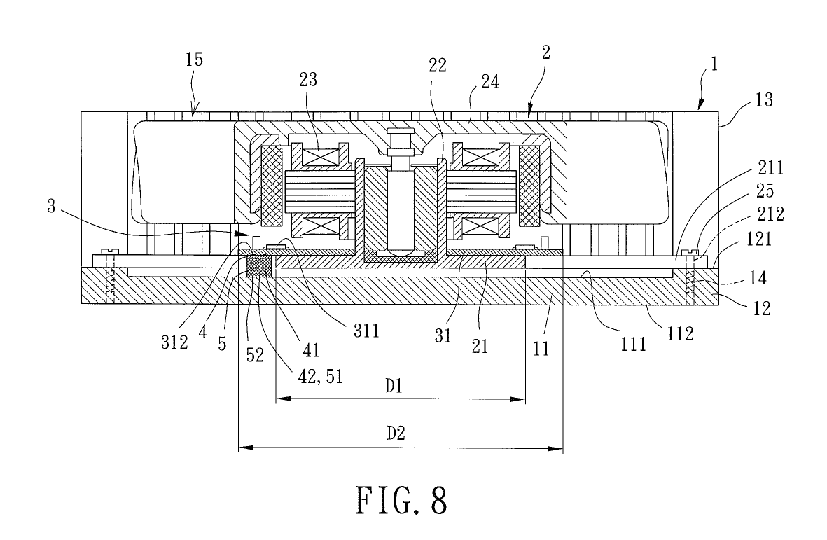

Referring to FIGS. 3 and 4 again, the base 21 preferably has an indented hole 213 (or through-hole) when the circuit board 31 is directly disposed on the base 21, with the indented hole 213 being on a periphery of the base 21. The first electrical connection port 312 and the temperature sensor 4 are aligned with the indented hole 213 in order for the resilient heat conductor 5 to contact the seat 11 via the indented hole 213. In addition, as shown in FIG. 5, the indented hole 213 may further allow alignment of the temperature sensor 4 and the resilient heat conductor 5. Thus, assembly convenience of the cooling module is improved. Alternatively, as shown in FIG. 8, a maximal diameter D1 of the base 21 is preferably smaller than a maximal diameter D2 of the circuit board 31 when the circuit board 31 is directly disposed on the base 21. Based on this, the temperature sensor 4 and the resilient heat conductor 5 are aligned with each other on an outer periphery of the circuit board 31, allowing the resilient heat conductor 5 to contact the seat 11 of the heat sink 1 without the indented hole 213.

Referring to FIGS. 3 and 4 again, based on the height difference between the protruding face 121 and the first face 111, a spacing is formed between the seat 11 and the base 21 for accommodating the resilient heat conductor 5 when the supporting ribs 211 of the base 21 couple with the protruding face 121 of the heat sink 1. The spacing may provide space flexibility for deformation of the resilient heat conductor 5.

According to the above description, better detection ability of the temperature sensor 4 is ensured via the use of the resilient heat conductor 5. Furthermore, assembly convenience is improved as the resilient heat conductor 5 closely contacts the temperature sensor 4 and the seat 11.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A cooling module, comprising:
a heat sink;
a cooling fan facilitating cooling efficiency of the heat sink;
a control assembly having a circuit board controlling rotation of the cooling fan;
a temperature sensor coupled to the circuit board of the control assembly and having a sensing face; and
a resilient heat conductor disposed between the heat sink and the temperature sensor and having a first contact face and a second contact face, wherein the first contact face contacts the sensing face of the temperature sensor and the second contact face contacts a face of the heat sink.

2. The cooling module as claimed in claim 1, wherein the heat sink comprises a seat having a first face and a second face opposing to the first face, the cooling fan comprises a base coupling with the seat of the heat sink, the sensing face of the temperature sensor faces the first face of the seat and contacts the first contact face of the resilient heat conductor, and the second contact face of the resilient heat conductor contacts the first face of the seat.

3. The cooling module as claimed in claim 2, wherein the circuit board of the control assembly comprises a first electrical connection port, the temperature sensor comprises a second electrical connection port coupled to the first electrical connection port.

4. The cooling module as claimed in claim 3, wherein the circuit board of the control assembly is disposed on the base of the cooling fan, the first electrical connection port faces the first face of the seat so as to couple to the second electrical connection port of the temperature sensor.

5. The cooling module as claimed in claim 4, wherein the base has an indented hole or through-hole, the indented hole is on a periphery of the base and the first electrical connection port and the temperature sensor are aligned with the indented hole or through-hole.

6. The cooling module as claimed in claim 4, wherein the base has a maximal diameter smaller than a maximal diameter of the circuit board, and the temperature sensor and the resilient heat conductor are aligned with each other on an outer periphery of the circuit board.

7. The cooling module as claimed in claim 3, wherein the circuit board of the control assembly is integrally formed with the base of the cooling fan.

8. The cooling module as claimed in claim 1, wherein the resilient heat conductor is in form of a block with flexibility.

9. The cooling module as claimed in claim 1, wherein the resilient heat conductor is in form of a block with insulation function.

10. The cooling module as claimed in claim 2, wherein the seat forms an outer annual portion along a periphery thereof, the outer annual portion has a protruding face, a height difference exists between the protruding face and the first face, the base has a plurality of supporting ribs extending from a periphery thereof, and the supporting ribs couple with the protruding face of the heat sink.

11. The cooling module as claimed in claim 10, wherein a spacing is formed between the seat and the base and the resilient heat conductor is received in the spacing.

12. The cooling module as claimed in claim 10, wherein the protruding face is mounted with a plurality of fins defining a receiving space, and the cooling fan is disposed in the receiving space.
